(19) United States
(12) Patent Application Publication
(10) Pub. No.: US 2006/0170871 A1
(43) Pub. Date: Aug. 3, 2006

(54) Anti-blinding safety feature for projection systems

(76) Inventors: Paul H. Dietz, Hopkinton, MA (US); Johnny Chung Lee, Pittsburgh, PA (US)

Correspondence Address: Patent Department;Mitsubishi Electric Research Laboratories, Inc., 201 Broadway, Cambridge, MA, 02139, US

(21) Appl. No.: 11/048,545

(22) Filed: Feb. 1, 2005

(51) Int. Cl. G03B 21/00

(52) U.S. Cl. 353/31; 353/28

(57) ABSTRACT

A method for projecting an image projects, optically, an image on a display surface. A presence of a person in a region of projection is detected and a brightness of the image is reduced in response to detecting the presence of the person in the region of projection.

### FIELD OF THE INVENTION

This invention relates generally to projection systems, and more particularly to controlling a brightness of a projected image.

### BACKGROUND OF THE INVENTION

Data and video projectors are quickly becoming brighter to allow more vivid and larger images. An unintended consequence of this is that it is becoming more and more problematic when people accidentally look directly into the projector's lens. This is especially true for children, who might stare into the beam for an extended period of time. The high brightness can cause discomfort, temporary blindness, or, in extreme cases, permanent vision damage. A safety feature is needed to prevent projecting high light levels directly into the eyes of a viewer.

The prior art includes several techniques for modifying the intensity and brightness of the projected image to automatically adjust for environmental lighting conditions, or by explicit control of a user. They also include technologies for preserving lamp life or the life of the imaging element in the projector.

Recent prior art has utilized a video camera and image processing technology to generate a silhouette around people who intersect the projection area, dimming only the appropriate regions. However, this technique requires a costly camera and substantial computational power to achieve the desired effect in real-time. It is therefore impractical to use on inexpensive video projectors.

Therefore, it is desired to provide a practical safety feature that prevents projecting high light levels directly into the eyes of a viewer.

### SUMMARY OF THE INVENTION

The present invention provides a system and method for automatically detecting the presence of a person in a projection region and decreasing the light to a low level while the person is present. After the projection region is absent of people, the light output is returned to normal levels.

### BRIEF DESCRIPTION OF THE DRAWINGS

FIG. 1 is a block diagram of one embodiment of a projector system according to the invention; and

FIG. 2 is a graph of a dimming function used by the system according to the invention.

### DETAILED DESCRIPTION OF THE PREFERRED EMBODIMENT

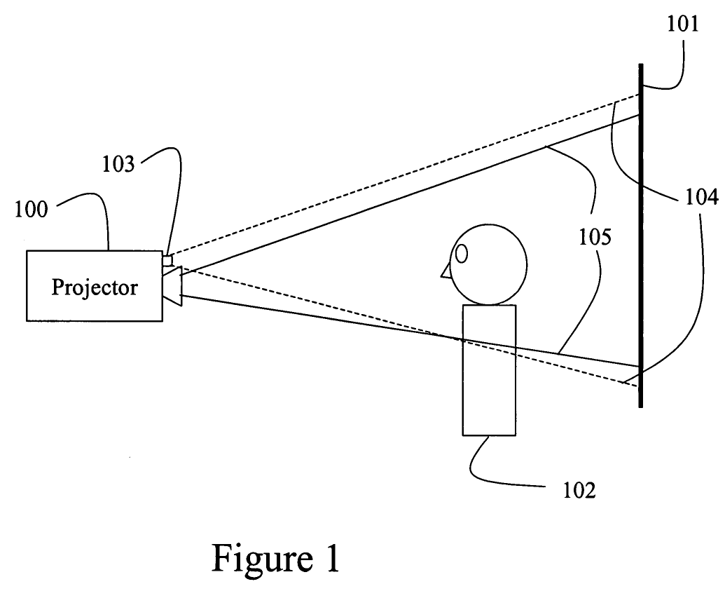

As shown in FIG. 1, a preferred embodiment of a brightness safety mechanism according to the invention includes an image projector 100 capable of presenting images through a projection region 105 onto a display surface 101. When a viewer 102 steps into a sensing region 104 of a detector 103, a light output of the projector is decreased so that the viewer is not blinded.

Presence Detector

The detector 103 in the preferred embodiment of the system is a passive infrared motion sensor sensitive to human motion in the sensing region 104. Motion detectors are low-cost devices that detect human presence through motion. A more accurate measure of the presence of a viewer can be used for this safety system to improve the reliability of the system.

The spectrum of energy sensed by the passive IR sensor 103 is exclusive of the spectrum of energy that is output by the projector 100 onto the display surface 101. This allows the field of view of the motion sensor to include the projection region while not being sensitive to motion in the projected image. Thus, fast changing video images do not result in misfiring of the safety mechanism. The sensing region of the motion detector 104 can be matched to the projection region 105 to minimize false triggering from external motion outside the projection region.

Dimming Function

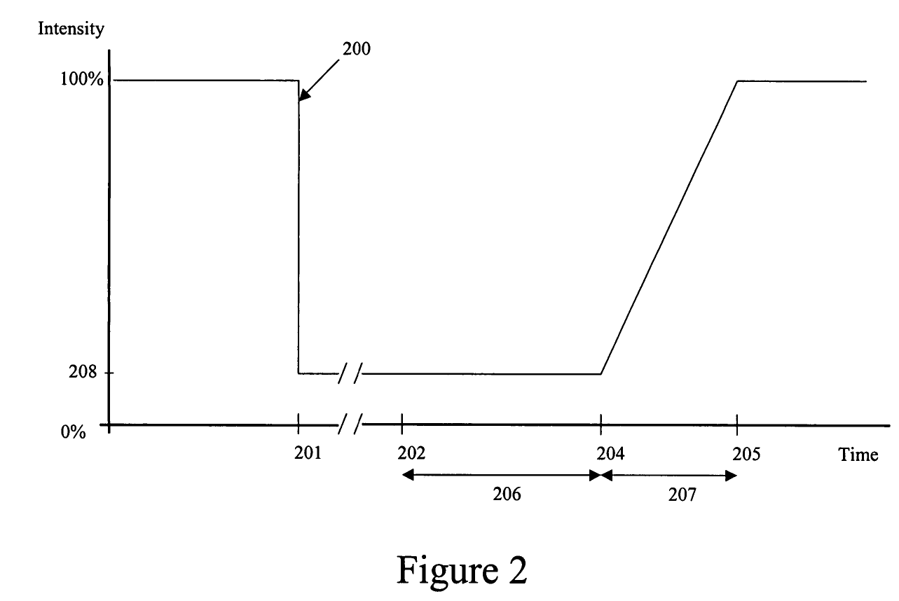

FIG. 2 shows a dimming function 200 used by the projector to reduce and restore the image intensity of the projected image. The function has intensity on the vertical axis, and time on the horizontal axis.

When motion occurs within the sensing region at time 201, the projector brightness is immediately reduced to a low intensity 208. This low intensity level is about 10% of the full intensity of the projector. The purpose of not reducing the intensity down to 0% is to prevent the viewers from falsely presuming that the projector is malfunctioning. A residual image, still visible at 10%, differentiates between a state of safely dimmed mode and projector failure.

When motion is no longer detected at a time 202, the system waits a designated time delay 206. If the system has not detected any further motion after the time delay 206 has expired, at time 204, the system gradually returns the output of the projector to full brightness over a time period 207. At time 205, the brightness of the projector has been restored to normal operating levels.

In the preferred embodiment of the safety system, the time delay 206 is about four seconds and the time delay 207 is about two seconds. Restoring the brightness of the projector gradually over a short period of time minimizes surprise and visual discomfort of viewers particularly when the projector is the primary source of light in a darkened room. These delay times were chosen arbitrarily and seemed reasonable in practice, but they may vary in different embodiments.

Though a linear ramping function is used during time period 207 to restore the brightness level to 100%, alternative functions can be use used such as exponential curve or a slow-in, slow-out “S” like transitional curve. These functions all produce the same result, but result in slightly different appearances: and perceptual effects. The function choice can minimize visual discomfort under low light conditions.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A projector system, comprising:
means for projecting, optically, an image on a display surface;
means for detecting a presence of a person in a region of projection; and
means for reducing a brightness of the image in response to the detected presence of the person in the region of projection.

2. The projector system of claim 1, in which the projected image is a video.

3. The projector system of claim 1, in which the detector is a passive infrared motion sensor.

4. The projector system of claim 1, in which a spectrum of energy sensed by the means for sensing is exclusive of a spectrum of energy that is output by the means for projecting.

5. The projector system of claim 1, in which an area of a field of view of the display surface is substantially equal to an area of sensing.

6. The projector system of claim 1, in which the brightness of the image is increased if an absence of the person is detected.

7. The projector system of claim 1, in which the reducing is according to a dimming function expressed as light intensity over time.

8. The projector system of claim 7, in which the brightness, after the reducing, projects a residual image on the display surface.

9. The projector system of claim 8, in which the residual image has an intensity that is 10% of the projected image.

10. The projector system of claim 7, in which the dimming function is a linear ramping function.

11. The projector system of claim 7, in which the dimming function is an exponential curve.

12. A projector system, comprising:
a projector configured to project, optically, an image on a display surface;
a sensor configured to detect a presence of a person in a region of projection; and
means for reducing a brightness of the image in response to the detected presence of the person in the region of projection.

13. A method for projecting an image, comprising:
projecting, optically, an image on a display surface;
detecting a presence of a person in a region of projection; and
reducing a brightness of the image in response to detecting the presence of the person in the region of projection.
